(19) United States
(12) Patent Application Publication
(10) Pub. No.: US 2014/0091775 A1
(43) Pub. Date: Apr. 3, 2014

(54) TWO-STAGE LOW-DROPOUT LINEAR POWER SUPPLY SYSTEMS AND METHODS

(71) Applicant: NORTHROP GRUMMAN SYSTEMS CORPORATION, Falls Church, VA (US)

(72) Inventors: FANG DONG TAN, IRVINE, CA (US); JEFF ZEE, LOS ANGELES, CA (US)

(73) Assignee: NORTHROP GRUMMAN SYSTEMS CORPORATION, Falls Church, VA (US)

(21) Appl. No.: 13/633,568

(22) Filed: Oct. 2, 2012

(51) Int. Cl. G05F 1/575

(52) U.S. Cl. 323/280

(57) ABSTRACT

Aspects of the present invention include a low-dropout (LDO) linear power supply system. The system includes a pass-element configured to generate an output voltage at an output based on an input voltage. The system also includes a compensation amplifier stage coupled to the output and configured to provide frequency compensation and provide a desired frequency response of the output voltage. The system further includes a gain amplifier stage interconnecting the compensation amplifier stage and the pass-element and configured to provide DC gain scaling to generate the output voltage substantially proportional to the input voltage within a given range of the input voltage.

### TECHNICAL FIELD

The present invention relates generally to electronic circuits, and specifically to two-stage low-dropout linear power supply systems and methods.

### BACKGROUND

There is an ever increasing demand for power conversion and regulation circuitry to operate with increased efficiency. One such type of regulator circuit is known as a low-dropout (LDO) linear power supply (linear regulator). An LDO linear power supply can be characterized as a DC/DC linear voltage regulator that can operate with a very small differential between the input voltage and the output voltage. LDO power supplies can exhibit a number of advantages over typical linear power supplies, in that an LDO linear power supply can typically operate with a lower minimum operating voltage and can typically have a higher efficiency operation and lower heat dissipation. General challenges for an LDO design can include ensuring low drop-out and stability over a wide range of load and output capacitance values.

### SUMMARY

One aspect of the present invention includes a low-dropout (LDO) linear power supply system. The system includes a pass-element configured to generate an output voltage at an output based on an input voltage. The system also includes a compensation amplifier stage coupled to the output and configured to provide frequency compensation and provide a desired frequency response of the output voltage. The system further includes a gain amplifier stage interconnecting the compensation amplifier stage and the pass-element and configured to provide DC gain scaling to generate the output voltage substantially proportional to the input voltage within a given range of the input voltage.

Another embodiment of the present invention includes an LDO linear power supply system. The system includes a pass-element configured to generate an output voltage at an output based on an input voltage. The system also includes a compensation amplifier stage coupled to the output and configured to provide frequency compensation and provide a desired frequency response of the output voltage. The system also includes a gain amplifier stage interconnecting the compensation amplifier stage and the pass-element and configured to provide DC gain scaling to generate the output voltage substantially proportional to the input voltage within a given range of the input voltage. The system further includes a capacitor and an associated equivalent series resistor (ESR) coupled to the output to provide output filtering of the output voltage.

Another embodiment of the present invention includes an integrated circuit (IC) chip comprising an LDO linear power supply system. The system includes a pass-element configured to generate an output voltage at an output based on an input voltage. The system also includes a compensation amplifier stage coupled to the output and comprising a compensation operational amplifier (OP-AMP) configured to generate a stabilization voltage in response to a feedback voltage associated with the output voltage and a reference voltage. The compensation amplifier stage can be configured to provide frequency compensation and provide a desired frequency response of the output voltage. The system also includes a gain amplifier stage interconnecting the compensation amplifier stage and the pass-element and comprising a gain OP-AMP configured to receive the stabilization voltage at a first input and to generate a control voltage at an output. The control voltage can be provided to control the pass-element at a control input, the gain amplifier stage being configured to provide DC gain scaling to generate the output voltage substantially proportional to the input voltage. The system further includes terminals configured to receive a capacitor and an associated equivalent series resistor (ESR) coupled to the output external to the IC to provide output filtering of the output voltage.

### BRIEF DESCRIPTION OF THE DRAWINGS

FIG. 1 illustrates an example of a low-dropout (LDO) linear power supply system in accordance with an aspect of the invention.

FIG. 2 illustrates an example of an LDO linear power supply circuit in accordance with an aspect of the invention.

FIG. 3 illustrates another example of an LDO linear power supply circuit in accordance with an aspect of the invention.

### DETAILED DESCRIPTION

The present invention relates generally to electronic circuits, and specifically to two-stage low-dropout (LDO) linear power supply systems and methods. The LDO linear power supply system includes a pass element that is configured to generate an output voltage at an output of the LDO linear power supply system based on an input voltage. The output voltage can be substantially proportional to the input voltage within a given range of the input voltage, above which the output voltage can be approximately constant based on saturation of the pass element. As an example, the pass element can be configured, within the general framework, as an N-channel metal oxide semiconductor field-effect transistor (MOSFET), a P-channel MOSFET, an NPN bipolar junction transistor (BJT), a PNP BJT, or as a Darlington pair of transistors (e.g., NPN or PNP BJTs).

The LDO linear power supply system also includes a first amplifier stage configured as a compensation amplifier stage that is coupled to the output of the LDO linear power supply system. As an example, the compensation amplifier stage includes an inverting operational amplifier (OP-AMP) and a plurality of resistive-capacitive (RC) networks. The inverting OP-AMP is configured to generate a stabilization voltage based on a feedback voltage associated with the output voltage and a reference voltage. The RC networks can include an RC feed-forward network coupled between the output and a first input of the compensation OP-AMP and an RC feedback network coupled between the first input and an output of the compensation OP-AMP. The RC feed-forward and feedback networks can cooperate to affect the frequency response of the output voltage and to provide substantially rapid transient response of the stabilization voltage with step loads.

The LDO linear power supply system also includes a second amplifier stage configured as a gain amplifier stage that interconnects the pass element and the compensation amplifier stage. Therefore, the gain amplifier stage operates to buffer the pass element from the stabilization voltage output from the inverting OP-AMP. For example, the gain amplifier stage includes a gain OP-AMP configured to receive the stabilization voltage and to generate a control voltage having a magnitude that is proportional to the stabilization voltage. The control voltage is provided to a control input of the pass element to operate the pass element in one of a linear mode and a saturation mode, thus allowing the output voltage to be substantially proportional to the input voltage through a given range of the input voltage.

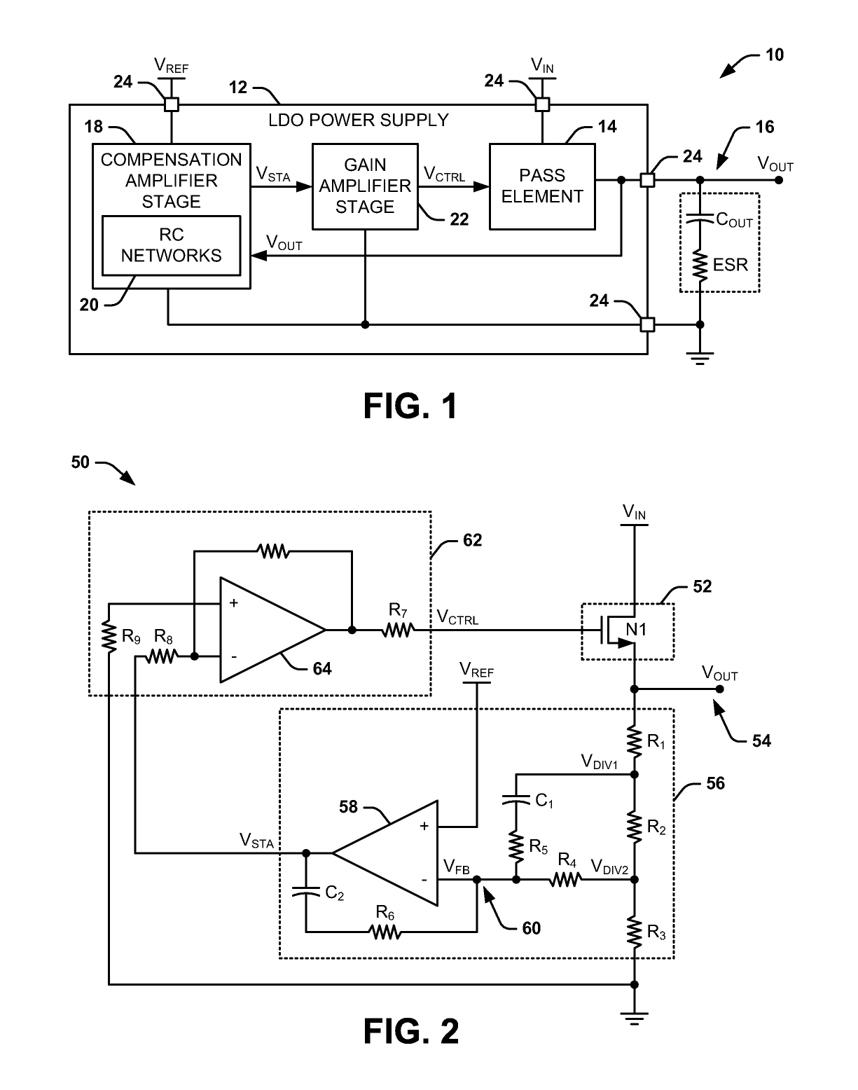

FIG. 1 illustrates an example of a low-dropout (LDO) linear power supply system 10 in accordance with an aspect of the invention. The LDO linear power supply 10 is configured to generate an output voltage V_{OUT} that has a magnitude that is substantially proportional to an input voltage V_{IN} through a given range of the input voltage V_{IN}. As an example, in response to the input voltage V_{IN} increasing to a magnitude that is greater than threshold magnitude, the output voltage V_{OUT} may be provided at an approximately constant maximum magnitude. The LDO linear power supply system 10 can be implemented in any of a variety of applications in which the output voltage V_{OUT} is to be provided at a substantially stable magnitude based on the input voltage V_{IN}, as described in greater detail herein.

The LDO linear power supply system 10 includes an LDO linear power supply 12, which can be arranged in an integrated circuit (IC) chip. The LDO linear power supply 12 includes a pass element 14, which can be configured as a transistor. The pass element 14 interconnects the input voltage V_{IN} and the output voltage V_{OUT} at an output 16. For example, the pass element 14 can be configured as an N-channel metal oxide semiconductor field-effect transistor (MOSFET), a P-channel MOSFET, an NPN bipolar junction transistor (BJT), a PNP BJT, or as a Darlington pair of transistors (e.g., NPN or PNP BJTs). As an example, the pass element 14 can be implemented as a P-channel MOSFET, a PNP BJT, or as a Darlington pair comprising a set of PNP BJTs to provide the output voltage V_{OUT} as a negative voltage.

The LDO linear power supply 12 also includes a compensation amplifier stage 18 that is coupled to the output 16. The compensation amplifier stage 18 is configured to generate a stabilization voltage V_{STA} that is associated with the output voltage V_{OUT} at the output 16. As an example, the compensation amplifier stage 18 includes a compensation operation amplifier (OP-AMP) that is configured to generate the stabilization voltage V_{STA} at an output based on a reference voltage V_{REF} and a feedback voltage that is associated with the output voltage V_{OUT}. In addition, the compensation amplifier stage 18 includes a plurality of resistive-capacitive (RC) networks 20 that cooperate to affect a frequency response of the stabilization voltage V_{STA}, and thus the output voltage V_{OUT}, and to provide substantially rapid transient response of the stabilization voltage V_{STA}.

The stabilization voltage V_{STA} is provided to a gain amplifier stage 22 that interconnects the pass element 14 and the compensation amplifier stage 18. The gain amplifier stage 22 is configured to generate a control voltage V_{CTRL} that is provided to a control input of the pass element 14, such that the pass element 14 can be operated in a linear region through the given range of magnitudes of the input voltage V. As an example, the gain amplifier stage 22 includes a gain OP-AMP that generates the control voltage V_{CTRL} based on the stabilization voltage V_{STA}. For example, the control voltage V_{CTRL} can be substantially proportional to the stabilization voltage V_{STA}. Therefore, the control voltage V_{CTRL} can exhibit substantially the same frequency response and substantially rapid transient response as the stabilization voltage V_{STA} with step loads.

The LDO linear power supply 12 further includes terminals 24, such as contact terminals, leads, solder pads, or a variety of other external electrical connection points. In the example of FIG. 1, the terminals 24 are configured to receive the reference voltage V_{REF} and the input voltage V_{IN}, and to provide the output voltage V_{OUT} and a connection to a low-voltage rail, demonstrated in the example of FIG. 1 as ground. The terminals 24 that provide the output voltage V_{OUT} and the connection to ground can also be configured to receive an output capacitor C_{OUT} and an equivalent series resistor (ESR) connected to the LDO linear power supply 12 (e.g., external to the IC package). As an example, the ESR can correspond to a parasitic resistance associated with the output capacitor C_{OUT}.

By implementing the LDO linear power supply system 10 as a two-stage amplifier system, the LDO linear power supply system 10 can be implemented as a circuit having a relatively simple design but improved capability over typical LDO linear power supply systems. As one example, typical LDO linear power supply systems utilize both output voltage filtering and frequency compensation (i.e., loop shaping) via the ESR provided by an external capacitor and external resistor connection. Such requirements of output voltage filtering and frequency compensation for an LDO linear power supply system can conflict with each other, such that zero of the of the respective output capacitor is implemented for loop stability while the ESR that includes the respective output capacitor is implemented for output filtering. Such a requirement conflict can result in a very narrow region of stability with respect to output current as a function of ESR, thus creating a stability region typically known as a “Tunnel of Death”, outside of which the stability of the LDO linear power supply system is compromised. The LDO linear power supply system 10 overcomes the narrow “Tunnel of Death” problem by separating the functions of output filtering and frequency compensation, such that the output capacitor C_{OUT} and the ESR provide output filtering of the output voltage V_{OUT}, while the compensation amplifier stage 18 provides frequency compensation of the LDO linear power supply system 10 independently of the output capacitor C_{OUT} (i.e., without implementing the zero of the output capacitor C_{OUT}). As a result, the LDO linear power supply system 10 can exhibit much greater stability over a wider range of component values of the output capacitor C_{OUT}, and thus the ESR, without compromising the output filtering function of the output capacitor C_{OUT} and the desired frequency response.

In addition, typical LDO linear power supply systems implement only a single amplifier stage that interconnects the feedback associated with the output voltage with the control input of an associated pass element, thus driving the pass element with a signal that is based more directly on the output voltage. Therefore, the robustness of typical LDO linear power supply systems can also be compromised over variations of load with respect to cross-over frequency, gain and phase margins, and power supply rejection of the typical LDO linear power supply. By incorporating both the compensation amplifier stage 18 and the gain amplifier stage 22 in the two-stage implementation, the gain amplifier stage 22 provides sufficient buffering between the pass element 14 and the frequency compensation of the output voltage V_{OUT} to decouple a loading effect on the pass element 14. Described another way, the compensation amplifier stage 18 provides buffering between the output voltage V_{OUT} and the DC gain scaling provided by the gain amplifier stage 22. Therefore, the LDO linear power supply system 10 can maintain sufficient cross-over frequency, gain and phase margins, and power supply rejection over a variety of loading conditions. In addition, by implementing two amplifier stages, the LDO linear power supply system 10 can maintain a relatively simple design while achieving substantially improved performance relative to typical LDO linear power supply systems. Furthermore, the simplistic design of the LDO linear power supply system 10 is such that any of a variety of pass-elements can be accommodated with minimal variation, such that the LDO linear power supply system 10 can be flexible with respect to the circuit components implemented therein to provide ultra-low-dropout capability in generating the output voltage V_{OUT}.

FIG. 2 illustrates an example of an LDO linear power supply circuit 50 in accordance with an aspect of the invention. The LDO linear power supply circuit 50 can be included in an IC chip (i.e., IC package). The LDO linear power supply circuit 50 can correspond to the LDO linear power supply 12 in the example of FIG. 1. Therefore, reference can be made to the example of FIG. 1 in the following description of the example of FIG. 2.

The LDO linear power supply circuit 50 is configured to generate an output voltage V_{OUT} that has a magnitude that is substantially proportional to an input voltage V_{IN} through a given range of the input voltage V. As an example, in response to the input voltage V_{IN} increasing to a magnitude that is greater than threshold magnitude, the output voltage V_{OUT} may be provided at an approximately constant maximum magnitude. The LDO linear power supply circuit 50 can be implemented in any of a variety of applications in which the output voltage V_{OUT} is to be provided at a substantially stable magnitude based on the input voltage V_{IN}, as described in greater detail herein.

The LDO linear power supply circuit 50 includes a pass element 52, demonstrated in the example of FIG. 2 as an N-channel MOSFET (N-FET) N₁. The N-FET N₁ is coupled to the input voltage V_{IN} at a drain and an output 54 to provide the output voltage V_{OUT} via a source. In the example of FIG. 2, the N-FET N₁ receives a control voltage CTRL at a gate to control the N-FET N₁ in a linear region through a given range of magnitudes of the input voltage V_{IN}.

The LDO linear power supply circuit 50 also includes a compensation amplifier stage 56 that is coupled to the output 54. The compensation amplifier stage 56 includes a compensation OP-AMP 58 that is configured to generate a stabilization voltage V_{STA} based on a reference voltage V_{REF} at a non-inverting input and a feedback voltage V_{FB} at an inverting input coupled to a node 60. Therefore, the compensation OP-AMP 58 is configured as an inverting OP-AMP to provide for fast transient response for slew of the compensation OP-AMP 58. The compensation amplifier stage 56 also includes a set of resistors R₁, R₂, and R₃ that interconnect the output 54 and a low-voltage rail, demonstrated in the example of FIG. 2 as ground. The resistors R₁ and R₂ form a first voltage-divider to generate a voltage V_{DIV1} and the resistors R₂ and R₃ form a second voltage-divider to generate a voltage V_{DIV2}. The feedback voltage V_{FB} is generated at the node 60 based on the voltage V_{DIV1} via a resistive-capacitive feed-forward network formed by a capacitor C₁ and a resistor R₄, based on the voltage V_{DIV2} via a resistor R₅, and based on the stabilization voltage V_{STA} via a resistive-capacitive feedback network formed by a capacitor C₂ and a resistor R₆. Therefore, the feedback voltage V_{FB} is generated based on the output voltage V_{OUT} and the stabilization voltage V_{STA}. The compensation OP-AMP 58 thus acts as an error amplifier to generate the stabilization voltage V_{STA} to provide frequency compensation of the LDO linear power supply circuit 50 to affect the frequency response of the stabilization voltage V_{STA}, and thus the output voltage V_{OUT}, and to provide substantially rapid transient response of the stabilization voltage V_{STA}.

The stabilization voltage V_{STA} is provided to a gain amplifier stage 62 that interconnects the pass element 52 and the compensation amplifier stage 56. The gain amplifier stage 62 includes a gain OP-AMP 64 that is configured to generate a control voltage V_{CTRL} via a resistor R₇. The control voltage V_{CTRL} is provided to a gate of the N-FET N₁, such that the N-FET N₁ can be operated in a linear region through the given range of magnitudes of the input voltage V_{IN}. In the example of FIG. 2, the gain OP-AMP 64 receives the stabilization voltage V_{STA} at an inverting input of the gain OP-AMP 64 via a resistor R₈ and is coupled to ground at a non-inverting input via a resistor R₉. In addition, a feedback resistor R₁₀ interconnects an output and the inverting input of the gain OP-AMP 64. Therefore, the gain OP-AMP 64 is configured to provide DC gain scaling of the stabilization voltage V_{STA} in generating the control voltage V_{CTRL} and to provide buffering to decouple the load impedance from impacting the frequency response of the compensation OP-AMP 58. As a result, the control voltage V_{CTRL} can exhibit substantially the same frequency response and substantially rapid transient response as the stabilization voltage V_{STA}. Accordingly, the N-FET N₁ can be operated in a linear region through a given range of magnitudes of the input voltage V_{IN} based on the control voltage V_{CTRL}.

It is to be understood that the LDO linear power supply circuit 50 is not intended to be limited to the example of FIG. 2. For example, the LDO linear power supply circuit 50 can be implemented with additional or alternative circuit components to achieve substantially the same desired effects with respect to the compensation stage 56 and/or the gain stage 62. In addition, the pass element 52 is not limited to being implemented as an N-FET, but could instead be implemented as an NPN BJT or an NPN Darlington pair, such that pass element 52 can be controlled by a current provided through the resistor R₇. Accordingly, the LDO linear power supply circuit 50 can be configured in a variety of ways.

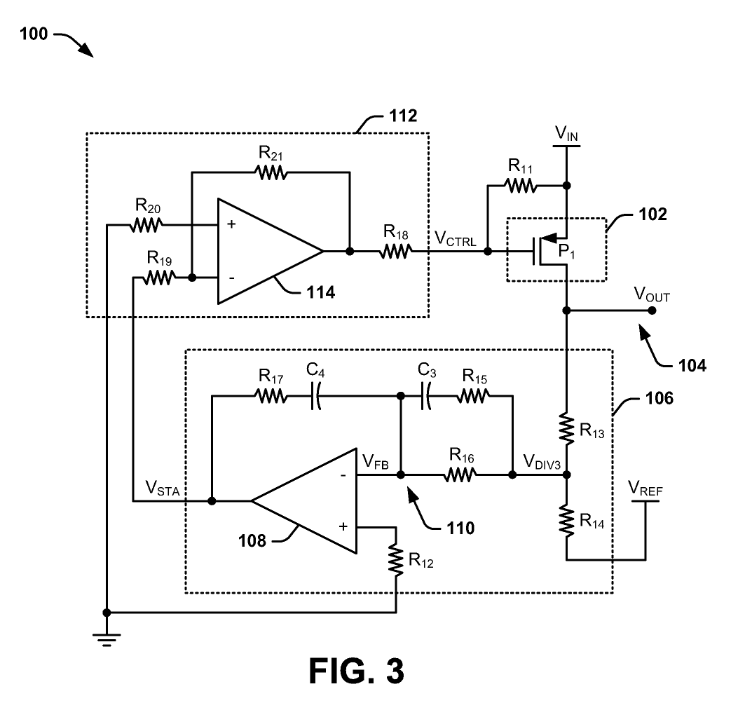

FIG. 3 illustrates another example of an LDO linear power supply circuit 100 in accordance with an aspect of the invention. The LDO linear power supply circuit 100 can be included in an IC chip (i.e., IC package). The LDO linear power supply circuit 100 can correspond to the LDO linear power supply 12 in the example of FIG. 1. Therefore, reference can be made to the example of FIG. 1 in the following description of the example of FIG. 3.

The LDO linear power supply circuit 100 is configured to generate an output voltage V_{OUT} that has a magnitude that is substantially proportional to an input voltage V_{IN} through a given range of the input voltage V. As described in greater detail herein, the output voltage V_{OUT} can be a negative voltage in the example of FIG. 3. As an example, in response to the input voltage V_{IN} decreasing to a magnitude that is less than threshold magnitude, the output voltage V_{OUT} may be provided at an approximately constant minimum magnitude. The LDO linear power supply circuit 100 can be implemented in any of a variety of applications in which the output voltage V_{OUT} is to be provided at a substantially stable magnitude based on the input voltage V_{IN}, as described in greater detail herein.

The LDO linear power supply circuit 100 includes a pass element 102, demonstrated in the example of FIG. 3 as a P-channel MOSFET (P-FET) P₁. The P-FET P₁ is coupled to the input voltage V_{IN} at a source and an output 104 to provide the output voltage V_{OUT} via a drain. In the example of FIG. 3, the P-FET P₁ receives a control voltage V_{CTRL} at a gate to control the P-FET P₁ in a linear region through a given range of magnitudes of the input voltage V_{IN}. A resistor R₁₁ interconnects the input voltage V_{IN} and the control voltage V_{CTRL} and provides a desired bias for startup conditions.

The LDO linear power supply circuit 100 also includes a compensation amplifier stage 106 that is coupled to the output 104. The compensation amplifier stage 106 includes a compensation OP-AMP 108 that is configured to generate a stabilization voltage V_{STA} based on being coupled to a low-voltage rail via a resistor R₁₂ at a non-inverting input and a feedback voltage V_{FB} at an inverting input coupled to a node 110. Therefore, the compensation OP-AMP 108 is configured as an inverting OP-AMP to provide for fast transient response for slew of the compensation OP-AMP 108. The compensation amplifier stage 106 also includes a set of resistors R₁₃ and R₁₄ that interconnect the output 104 and a reference voltage V_{REF}. The resistors R₁₃ and R₁₄ form a voltage-divider to generate a voltage V_{DIV3}. The feedback voltage V_{FB} is generated at the node 110 based on the voltage V_{DIV3} via a resistive-capacitive feed-forward network formed by a capacitor C₃ and a resistor R₁₅ and via a resistor R₁₆, and based on the stabilization voltage V_{STA} via a resistive-capacitive feedback network formed by a capacitor C₄ and a resistor R₁₇. Therefore, the feedback voltage V_{FB} is generated based on the output voltage V_{OUT} and the stabilization voltage V_{STA}. The compensation OP-AMP 108 thus acts as an error amplifier to generate the stabilization voltage V_{STA} to provide frequency compensation of the LDO linear power supply circuit 100 to affect the frequency response of the stabilization voltage V_{STA}, and thus the output voltage V_{OUT}, and to provide substantially rapid transient response of the stabilization voltage V_{STA}.

The stabilization voltage V_{STA} is provided to a gain amplifier stage 112 that interconnects the pass element 102 and the compensation amplifier stage 106. The gain amplifier stage 112 includes a gain OP-AMP 114 that is configured to generate a control voltage V_{CTRL} via a resistor R₁₈. The control voltage V_{CTRL} is provided to a gate of the P-FET P₁, such that the P-FET P₁ can be operated in a linear region through the given range of magnitudes of the input voltage V_{IN}. In the example of FIG. 3, the gain OP-AMP 114 receives the stabilization voltage V_{STA} at an inverting input of the gain OP-AMP 114 via a resistor R₁₉ and is coupled to ground at a non-inverting input via a resistor R₂₀. In addition, a feedback resistor R₂₁ interconnects an output and the inverting input of the gain OP-AMP 114. Therefore, the gain OP-AMP 114 is configured to provide DC gain scaling of the stabilization voltage V_{STA} in generating the control voltage V_{CTRL}. As a result, the control voltage V_{CTRL} can exhibit substantially the same frequency response and substantially rapid transient response as the stabilization voltage V_{STA}. Accordingly, the P-FET P₁ can be operated in a linear region through a given range of magnitudes of the input voltage V_{IN} based on the control voltage V_{CTRL}.

It is to be understood that the LDO linear power supply circuit 100 is not intended to be limited to the example of FIG. 3. For example, the LDO linear power supply circuit 100 can be implemented with additional or alternative circuit components to achieve substantially the same desired effects with respect to the compensation stage 106 and/or the gain stage 112. In addition, the pass element 102 is not limited to being implemented as an P-FET, but could instead be implemented as a PNP BJT or a PNP Darlington pair, such that pass element 102 can be controlled by a current provided through the resistor R₁₈. Accordingly, the LDO linear power supply circuit 100 can be configured in a variety of ways.

What have been described above are examples of the invention. It is, of course, not possible to describe every conceivable combination of components or method for purposes of describing the invention, but one of ordinary skill in the art will recognize that many further combinations and permutations of the invention are possible. Accordingly, the invention is intended to embrace all such alterations, modifications, and variations that fall within the scope of this application, including the appended claims.

What is claimed is:

1. A low-dropout (LDO) linear power supply system comprising:
a pass-element configured to generate an output voltage at an output based on an input voltage;
a compensation amplifier stage coupled to the output and configured to provide frequency compensation and provide a desired frequency response of the output voltage; and
a gain amplifier stage interconnecting the compensation amplifier stage and the pass-element and configured to provide DC gain scaling to generate the output voltage substantially proportional to the input voltage within a given range of the input voltage.

2. The system of claim 1, wherein the compensation amplifier stage comprises a compensation operational amplifier (OP-AMP) configured to generate a stabilization voltage in response to a feedback voltage associated with the output voltage and a reference voltage.

3. The system of claim 2, wherein the compensation amplifier stage comprises a resistive-capacitive feed-forward network coupled between the output and a first input of the compensation OP-AMP and a resistive-capacitive feedback network coupled between the first input and an output of the compensation OP-AMP, the resistive-capacitive feed-forward and feedback networks cooperating to affect the frequency response of the output voltage and to provide substantially rapid transient response of the stabilization voltage.

4. The system of claim 3, wherein the first input of the compensation OP-AMP is an inverting input, such that the compensation OP-AMP is configured as an inverting OP-AMP.

5. The system of claim 2, wherein the gain stage comprises a gain OP-AMP configured to receive the stabilization voltage at a first input and to generate a control voltage at an output, the control voltage being provided to control the pass-element at a control input.

6. The system of claim 5, wherein the control voltage has a magnitude that is proportional to the stabilization voltage.

7. The system of claim 2, wherein the reference voltage and the output voltage are interconnected by a voltage divider configured to generate the feedback voltage.

8. The system of claim 1, wherein the pass-element is configured as one of a bipolar junction transistor (BJT), a metal-oxide semiconductor field-effect transistor (MOSFET), and a Darlington pair of transistors.

9. An integrated circuit (IC) chip comprising the LDO linear power supply system of claim 1.

10. The IC chip of claim 9, wherein the IC chip comprises terminals configured to receive a capacitor and an associated equivalent series resistor (ESR) coupled to the output external to the IC to provide output filtering of the output voltage.

11. A low-dropout (LDO) linear power supply system comprising:
a pass-element configured to generate an output voltage at an output based on an input voltage;
a compensation amplifier stage coupled to the output and configured to provide frequency compensation and provide a desired frequency response of the output voltage;
a gain amplifier stage interconnecting the compensation amplifier stage and the pass-element and configured to provide DC gain scaling to generate the output voltage substantially proportional to the input voltage; and
a capacitor and an associated equivalent series resistor (ESR) coupled to the output to provide output filtering of the output voltage.

12. The system of claim 11, wherein the compensation amplifier stage comprises a compensation operational amplifier (OP-AMP) configured to generate a stabilization voltage in response to a feedback voltage associated with the output voltage and a reference voltage.

13. The system of claim 12, wherein the compensation amplifier stage comprises a resistive-capacitive feed-forward network coupled between the output and a first input of the compensation OP-AMP and a resistive-capacitive feedback network coupled between the first input and an output of the compensation OP-AMP, the resistive-capacitive feed-forward and feedback networks cooperating to affect the frequency response of the output voltage and to provide substantially rapid transient response of the stabilization voltage.

14. The system of claim 12, wherein the gain stage comprises a gain OP-AMP configured to receive the stabilization voltage at a first input and to generate a control voltage at an output, the control voltage being provided to control the pass-element at a control input.

15. The system of claim 12, wherein the reference voltage and the output voltage are interconnected by a voltage divider configured to generate the feedback voltage.

16. An integrated circuit (IC) chip comprising the LDO linear power supply system of claim 11, wherein the IC chip is configured to receive the capacitor and the resistor as an external capacitor and an external resistor.

17. An integrated circuit (IC) chip comprising a low-dropout (LDO) linear power supply system, the LDO linear power supply system comprising:
a pass-element configured to generate an output voltage at an output based on an input voltage;
a compensation amplifier stage coupled to the output and comprising a compensation operational amplifier (OP-AMP) configured to generate a stabilization voltage in response to a feedback voltage associated with the output voltage and a reference voltage, the compensation amplifier stage being configured to provide frequency compensation and provide a desired frequency response of the output voltage;
a gain amplifier stage interconnecting the compensation amplifier stage and the pass-element and comprising a gain OP-AMP configured to receive the stabilization voltage at a first input and to generate a control voltage at an output, the control voltage being provided to control the pass-element at a control input, the gain amplifier stage being configured to provide DC gain scaling to generate the output voltage substantially proportional to the input voltage; and
terminals configured to receive a capacitor and an associated equivalent series resistor (ESR) coupled to the output external to the IC to provide output filtering associated with the output voltage.

18. The system of claim 17, wherein the compensation amplifier stage comprises a resistive-capacitive feed-forward network coupled between the output and a first input of the compensation OP-AMP and a resistive-capacitive feedback network coupled between the first input and an output of the compensation OP-AMP, the resistive-capacitive feed-forward and feedback networks cooperating to affect the frequency response of the output voltage and to provide substantially rapid transient response of the stabilization voltage.

19. The system of claim 17, wherein the reference voltage and the output voltage are interconnected by a voltage divider configured to generate the feedback voltage.

20. The system of claim 17, wherein the first input of the compensation OP-AMP is an inverting input, such that the compensation OP-AMP is configured as an inverting OP-AMP.
